(19) United States
(12) Patent Application Publication
(10) Pub. No.: US 2019/0173240 A1
(43) Pub. Date: Jun. 6, 2019

(54) IN-VEHICLE CONTROL SYSTEM AND WIRE HARNESS

(71) Applicant: YAZAKI CORPORATION, Tokyo (JP)

(72) Inventors: Masashi Nakamura, Tochigi (JP); Masahiro Furukawa, Tochigi (JP); Satoshi Enomoto, Tochigi (JP); Akiyoshi Kanazawa, Tochigi (JP)

(21) Appl. No.: 16/208,470

(22) Filed: Dec. 3, 2018

(30) Foreign Application Priority Data
Dec. 4, 2017 (JP) 2017-232892

(51) Int. Cl. H01R 13/66; B60R 16/02; B60R 16/023; B60R 16/03

(52) U.S. Cl. CPC H01R 13/6691; B60R 16/03; B60R 16/0238; B60R 16/0207

(57) ABSTRACT

An in-vehicle control system includes a power distribution box which supplies electric power to a downstream side, an in-vehicle device having one or more loads, and a connection cable which connects the power distribution box to the in-vehicle device disposed in the downstream side of the power distribution box. The power distribution box includes a host controller. At least one connector attached to the connection cable includes a connector control unit. The host controller acquires via the connection cable and holds connector identification information previously assigned to the connector control unit.

### CROSS REFERENCE TO RELATED APPLICATIONS

This application claims priority from Japanese Patent Application No. 2017-232892 filed on Dec. 4, 2017, the entire contents of which are incorporated herein by reference.

### BACKGROUND OF THE INVENTION

### Field of the Invention

The present invention relates to an in-vehicle control system and a wire harness.

### Description of Related Art

Generally, in a vehicle, electrical components such as various loads, switches, sensors, electronic control units (ECUs), and the likes are arranged in various areas such as a door, a roof, a floor, and a seat. Further, electrical components of the respective areas are connected to each other via a wire harness, so that necessary electric power is respectively supplied to such electrical components from a vehicle side, a plurality of electrical components can communicate with each other, and necessary signals can be input and output.

When a control function such as a microcomputer is arranged for each area, it is possible to cope with the difference of the electrical components in each area according to, for example, the difference in the type of a vehicle or the change in the specification only by changing the software of the microcomputer or the like. However, when the microcomputers in respective areas are commonly connected to the same network on the vehicle, it is necessary to assign identification information such as a unique ID or the like to the microcomputer of each area and perform appropriate control for each ID.

Meanwhile, in a vehicle, there is a possibility of adding various pieces of equipment besides basic equipment, as optional equipment, with specification change, or according to the needs of a user. Therefore, it is necessary to supply electric power to additional equipment, generate a signal for controlling the equipment, and enable communication.

For example, the patent document 1: JP-A-2014-166019 relates to a wire harness and an electronic control device and discloses a technique for easily adding an electronic device. In addition, a vehicle harness structure of the patent document 1 discloses a technique for achieving commonality of the wire harness article numbers and eliminating the attachment of a wire harness.

### [Patent Document 1] JP-A-2014-166019

According to a related art, in an in-vehicle control system including a wire harness, when a power supply box which supplies electric power to a downstream side or a subordinate cable is designed, it is necessary to determine the number of circuits in each part, the function to be installed, the connection form, and the like in advance supposing various pieces of equipment which may be added.

Therefore, as in the configuration illustrated in FIG. 2 of the patent document 1, for example, a plurality of connectors are provided in a power supply box and a plurality of ECUs are respectively connected to the connectors via electric wires having different wire harnesses. Then, auxiliary devices such as various electronic devices are connected to the downstream side of each ECU.

In other words, the total number of connectors to be equipped in a power supply box, the number of electric wires of a wire harness, and the like must be predetermined according to additional equipment supposed at the time of designing. Therefore, when supposed equipment is too much, unnecessary connectors and electric wires not used are increased, and thus the cost of the system is increased. In addition, when the supposed equipment is insufficient, the equipment which can be added is limited, and thus it becomes difficult to respond to the specification changes and the request from a user.

In addition, as illustrated in FIG. 1 of the patent document 1, for example, when a control function is installed in a joint box, it is necessary to respectively install a standard control unit and an extended control unit. Here, with respect to the extended control unit, design must be made previously assuming various pieces of equipment which may be added. Alternatively, when there is a necessity for a specification change or the like, it is necessary to decide the function and configuration of a new extended control unit as a design change.

In other words, it is difficult to optimize the configuration when a power supply box or a subordinate cable is designed, and it is necessary to design new power supply boxes and cables of different configurations and to increase the types of parts which is brought about by a specification change of a vehicle, addition of equipment to be connected, and the like. Therefore, there is a concern that development man-hours accompanying reservation design of additional equipment increase, or the management cost or the cost of parts increases as the number of the types of parts increases.

### SUMMARY

One or more embodiments provide an in-vehicle control system and a wire harness which can flexibly cope with additions and changes of equipment which are unexpected at the time of design without an accompanying substantial configuration change.

In an aspect (1), an in-vehicle control system includes a power distribution box which supplies electric power to a downstream side, an in-vehicle device having one or more loads, and a connection cable which connects the power distribution box to the in-vehicle device disposed in the downstream side of the power distribution box. The power distribution box includes a host controller. At least one connector attached to the connection cable includes a connector control unit. The host controller acquires via the connection cable and holds connector identification information previously assigned to the connector control unit.

According to the aspect (1), the host controller can acquire the connector identification information given to the connector control unit of the connector connected to the downstream side thereof. Therefore, information necessary for controlling the in-vehicle device actually connected to the further downstream side of the connector control unit can be specified by the connector identification information. Thus, even when a new in-vehicle device which is not supposed at the time of designing is connected to the downstream side of the host controller, the host controller can appropriately control the in-vehicle device. As a result, it is possible to reduce the development man-hours accompanying reservation design of additional equipment. In addition, since there is no need to preliminarily incorporate parts which are less likely to be used in the power distribution box, the cost of parts can be reduced.

In an aspect (2), the power distribution box includes a plurality of standardized insertion ports to which one end of the connection cable is connectable. The host controller acquires the connector identification information via the connection cable according to a common control procedure even when the connection cable is connected to any of the plurality of standardized insertion ports.

According to the aspect (2), the specifications of the plurality of insertion ports are standardized. Thus, when each in-vehicle device is connected to the power distribution box via the connection cable, each connection cable can be connected to any of the plurality of insertion ports. Therefore, there is no mistake of the connection destination when the connection cable is connected and the cost of parts can also be reduced by standardized parts.

In an aspect (3), the connection cable includes a branch portion which branches to a plurality of paths. A plurality of the connectors are respectively connected to the plurality of the paths in the downstream side. A plurality of the connector identification information which is different is respectively assigned to the plurality of the connectors. A plurality of the in-vehicle devices are respectively connected to the plurality of the connectors.

According to the aspect (3), even when a plurality of insertion ports are not prepared in advance in the power distribution box, it is possible to connect a plurality of in-vehicle devices respectively or add in-vehicle devices by increasing the number of connectors connected to the branch destination of the connection cable.

In an aspect (4), the in-vehicle device includes a plurality of the loads or signal input devices. The connector control unit controls the plurality of the loads or the signal input device according to an instruction from the host controller.

According to the aspect (4), even when in-vehicle devices of various specifications with different number and types of loads and signal input devices are connected to the downstream side of the power distribution box, the difference in the specifications of respective in-vehicle devices can be absorbed by the control of the connector control unit. Therefore, it becomes easy to standardize the connection specifications between the host controller and the respective connector control units.

In an aspect (5), the host controller has a plurality of control operations which respectively correspond to the plurality of the connector identification information. The host controller controls the connector control unit with the control operation which is selected according to the connector identification information acquired via the connection cable.

According to the aspect (5), the host controller can execute appropriate control for each of a plurality of in-vehicle devices of different types and specifications by selecting one of the control operations according to the corresponding connector identification information. In addition, when a new control operation is added to the host controller, it also becomes possible to connect new additional equipment which is not supposed at the time of designing.

According to one or more embodiments, it is possible to flexibly cope with additions and changes of equipment which are unexpected at the time of designing, without substantial configuration changes. Therefore, it is possible to reduce the development man-hours accompanying reservation design of additional equipment. In addition, since there is no need to preliminarily incorporate parts which are less likely to be used in the power distribution box, the cost of parts can be reduced.

The invention has been briefly described above. Further, the details of the invention will be further clarified by reading the mode for carrying out the invention described below with reference to the accompanying drawings.

### BRIEF DESCRIPTION OF THE DRAWINGS

FIG. 1 is a plan view illustrating a specific example of a layout of major electrical components on a vehicle;

FIG. 2 is a block diagram illustrating a configuration example of an in-vehicle control system;

FIG. 3 is a block diagram illustrating another example of the configuration of the in-vehicle control system;

FIG. 4 is a sequence diagram illustrating an operation example of the in-vehicle control system;

FIGS. 5A and 5B are configuration diagrams illustrating an example of a connection cable;

FIG. 6 is a perspective view illustrating an example of a power distribution box; and

FIGS. 7A and 7B are configuration diagrams illustrating another example of the connection cable.

### DETAILED DESCRIPTION

A specific embodiment relating to the invention will be described below with reference to the drawings.

### [Arrangement Example of Major Electrical Components in Vehicle]

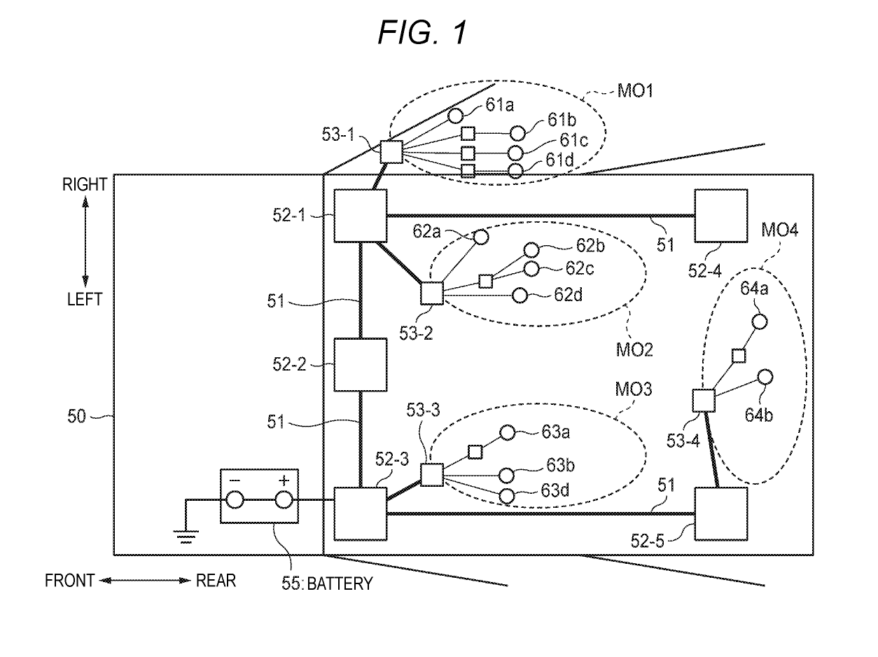

A specific example of a layout of major electrical components on a vehicle is illustrated in FIG. 1. FIG. 1 illustrates a state in which a vehicle body 50 is viewed from above, in which the left side indicates the front side and the right side indicates the rear side.

In the example illustrated in FIG. 1, a trunk line 51 of the wire harness extends in a right-left direction in the vicinity of a front side of a passenger compartment of the vehicle body 50, and further, the trunk line 51 branches from the vicinities of a left end and a right end and extends in a front-rear direction of the passenger compartment so that the trunk line 51 is arranged so as to form an “h” shape. The trunk line 51 is used for electric power transmission and communication. Further, a plurality of power distribution boxes 52-1, 52-2, 52-3, 52-4, and 52-5 are connected in a dispersed state to main locations of the trunk line 51. Basic functions of those power distribution boxes 52-1 to 52-5 are distribution of electric power supplied to subordinate loads (various electrical components), relay of communication, and the like. Further, a connection cable with a connector to be described below may also be a part of the wire harness.

The power output from an in-vehicle battery 55 is supplied to the other power distribution boxes 52-1, 52-2, 52-4, and 52-5 from the power distribution box 52-3 arranged on the left end side via the trunk line 51. Then, each of the power distribution boxes 52-1 to 52-4 distributes the electric power of the trunk line 51 and supplies it to the load of each part.

In the example illustrated in FIG. 1, the electrical components are modularized at each part of the vehicle body 50 and are arranged in each section as equipment modules MO1 to MO4. The equipment modules MO1, MO2, MO3, and MO4 respectively include electrical components of various kinds of in-vehicle equipment arranged in a door area, a floor area, a roof area, and a rear area of the vehicle body 50.

Specifically, the equipment module MO1 includes a door lock motor 61a, a power window motor 61b, a lamp 61c, an outer mirror 61d, and the like. The equipment module MO2 includes a courtesy switch 62a, an outer mirror switch 62b, a seat heater 62c, a hazard switch 62d, and the like. The equipment module MO3 includes a roof LED 63a, a vanity switch 63b, a vanity lamp 63d, and the like. The equipment module MO4 includes a rear LED 64a, an E latch 64b, and the like.

In the example illustrated in FIG. 1, the power distribution box 52-1 and the equipment module MO1 are connected to each other via a connection portion 53-1. Similarly, the power distribution box 52-1 and the equipment module MO2 are connected by a connection portion 53-2; the power distribution box 52-3 and the equipment module MO3 are connected by a connection portion 53-3; and the power distribution box 52-5 and the equipment module MO4 are connected by a connection portion 53-4. Each of the connection portions 53-1 to 53-4 is a connection cable including a connector.

Therefore, the electric power required by the electrical components of respective equipment modules MO1 to MO4 can be supplied via one of the power distribution boxes 52-1 to 52-5 and the connection portions 53-1 to 53-4. In the following description, when it is not necessary to distinguish between the power distribution boxes 52-1 to 52-5, it will be described as the power distribution box 52.

### [Configuration Example of In-Vehicle Control System]

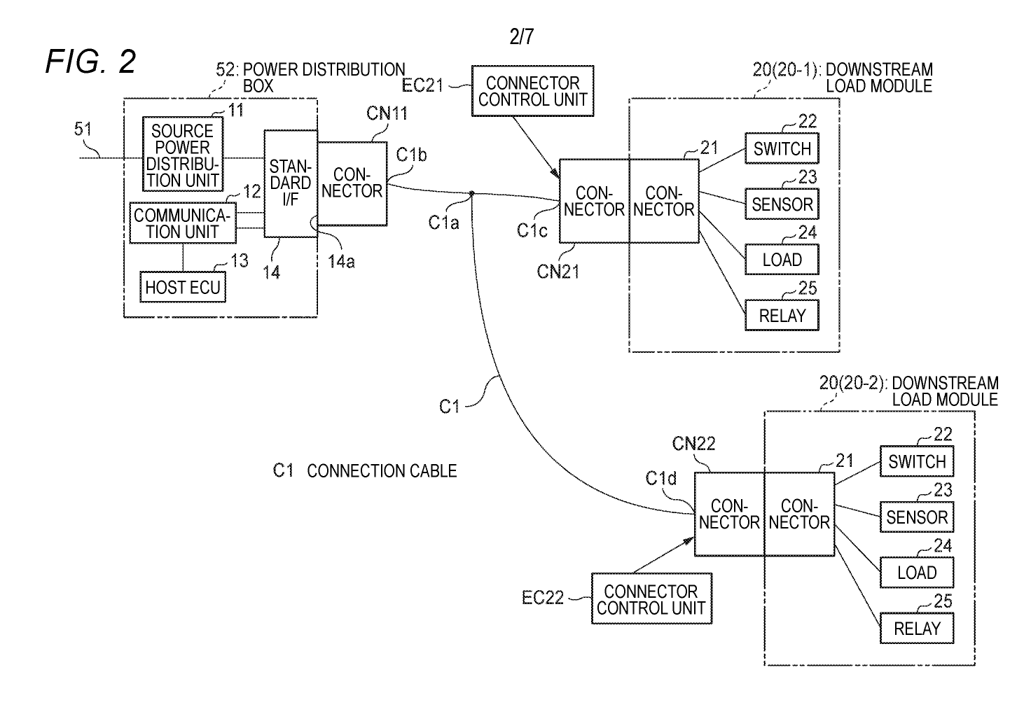

A configuration example of an in-vehicle control system according to the embodiment is illustrated in FIG. 2.

The in-vehicle control system illustrated in FIG. 2 includes a power distribution box 52, downstream load modules 20-1 and 20-2, and a connection cable C1. Here, the power distribution box 52, the downstream load modules 20-1 and 20-2, and the connection cable C1 can be respectively mounted on the vehicle body 50 as the power distribution box 52-1, the equipment modules MO1 and MO2, and the connection portion 53-1 (or 53-2) illustrated in, for example, FIG. 1. Of course, similar in-vehicle control systems can be configured for the other power distribution boxes 52-2 to 52-5.

The power distribution box 52 illustrated in FIG. 2 includes an electric power distribution unit 11, a communication unit 12, a host ECU (electronic control unit) 13, and a standard interface (I/F) 14. The electric power distribution unit 11 has a function of distributing the electric power supplied from the upstream side via the trunk line 51 and supplying it to the load on the downstream side. The host ECU 13 has a function of controlling the downstream load modules 20-1 and 20-2, and the likes via the connection cable C1. The communication unit 12 provides a function for the host ECU 13 to communicate with a device on the downstream side via the connection cable C1. Also, there is a case where a function for the host ECU 13 to communicate with another power distribution box via the trunk line 51 is mounted to the communication unit 12.

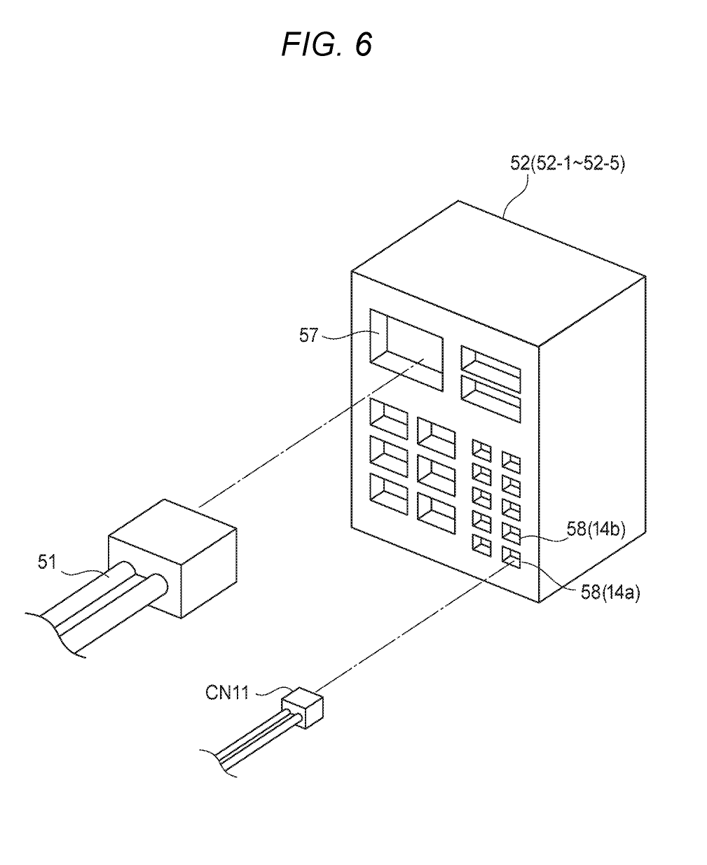

As illustrated in FIG. 6, the power distribution box 52 has a trunk line connection portion 57 to which the trunk line 51 is connected and which functions as a connector and a connector 58 to which a connector CN11 of the connection cable C 1 connected to each of the downstream load modules 20-1 and 20-2 is fitted. The connector 58 has a plurality of insertion ports 14a and 14b formed therein.

The standard interface 14 has the insertion port 14a in a standardized shape which can be fitted with the connector CN11. Further, it is also possible to prepare a plurality of similar insertion ports 14a in the standard interface 14. In addition, the insertion port 14a has terminals respectively for connecting a power supply line, a ground wire, and two communication lines.

Each of the downstream load modules 20-1 and 20-2 illustrated in FIG. 2 incorporates a connector 21, a switch 22, a sensor 23, a load 24, and a relay 25. Although not illustrated, a driver circuit for processing the signal input from the switch 22 and the sensor 23 and controlling the energization of the load 24 and the relay 25 is actually connected to the inside or the outside of each of the downstream load modules 20-1 and 20-2.

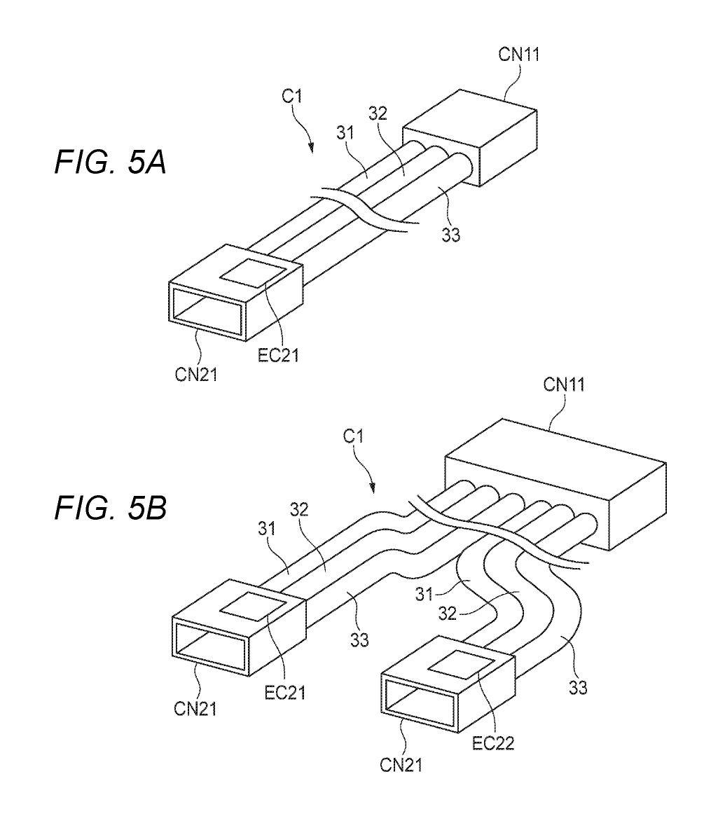

A configuration diagram of the connection cable C1 illustrated in FIG. 2 is illustrated in FIGS. 5A and 5B. The connection cable C1 is constituted of a power supply line 31, a ground wire 32, and a communication line 33 (for example, a twisted pair cable). The cable illustrated in FIG. 5A is used to connect the power distribution box 52 and the downstream load module 20 on a one-to-one basis. In addition, the connection cable C1 in FIG. 5B branches into a plurality of paths at a branch portion in the course of its length. The connector CN11 is connected to an end portion C1b on the upstream side and connectors CN21 and CN22 are respectively connected to end portions C1c and C1d on the downstream side.

The connector 21 of each of the downstream load modules 20-1 and 20-2 has an insertion port in a shape which can be fitted with the connector CN21 or CN22 of the connection cable C1. As illustrated in FIGS. 2, 5A and 5B, circuit boards of connector control units EC21 and EC22 are respectively provided in the housings of the connectors CN21 and CN22.

Each of the connector control units EC21 and EC22 holds information of a unique connector ID assigned in advance to each of the connector control units EC21 and EC22 and has a function of communicating with the host ECU13 of the power distribution box 52 and a function of inputting/outputting necessary signals to/from the connector 21. Each of the connector control units EC21 and EC22 is constituted by a microcomputer or a dedicated electronic circuit. The specific operation of each of the connector control units EC21 and EC22 will be described below.

The information on the connector ID held by each of the connector control units EC21 and EC22 is predetermined in advance so as to reflect the difference in the configuration, type, specification, and the like of the downstream load modules 20-1 and 20-2 connected to the downstream side thereof.

In the example of FIG. 2, the connector control units EC21 and EC22 are respectively arranged in the connectors CN21 and CN22 of the connection cable C1. However, the connector control units EC21 and EC22 may be arranged in the connectors 21 of the respective downstream load modules 20-1 and 20-2.

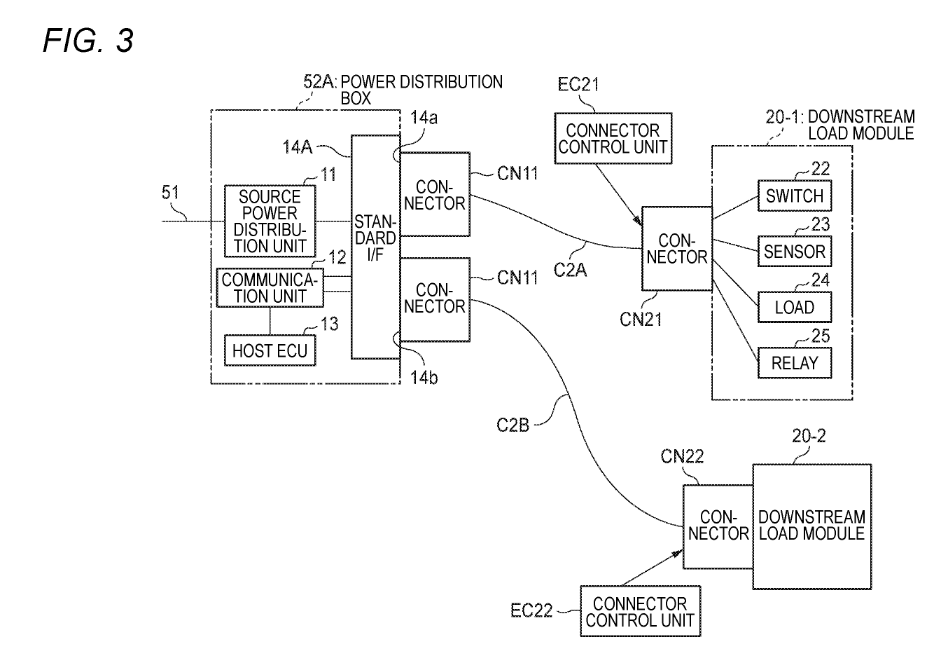

Further, the in-vehicle control system may be connected so as to have the configuration illustrated in FIG. 3.

In the in-vehicle control system of FIG. 3, a plurality of insertion ports 14a and 14b are prepared in the standard interface 14A of the power distribution box 52A in advance. Those insertion ports 14a and 14b have the same shape. The power distribution box 52A and the downstream load module 20-1 are connected via a connection cable C2A and the power distribution box 52A and the downstream load module 20-2 are connected via a connection cable C2B.

In the connection cable C2A, the connector CN11 is provided in one end and the connector CN21 is provided in the other end. The connector CN21 incorporates the circuit board of the connector control unit EC21. In the connection cable C2B, the connector CN11 is provided in one end and the connector CN22 is provided in the other end. The connector CN22 incorporates the circuit board of the connector control unit EC22.

In the configuration of FIG. 3, since the two insertion ports 14a and 14b have the same shape, the connector CN11 of the connection cable C2A can be inserted into any of the plurality of insertion ports 14a and 14b. Also, the connector CN11 of the connection cable C2B can be inserted into any of the plurality of insertion ports 14a and 14b.

Similar to the configuration of FIG. 2, also in the configuration of FIG. 3, the connector control unit EC21 holds the information of the connector ID according to the configuration, type, specification, and the like of the downstream load module 20-1 and the connector control unit EC22 holds the information of the connector ID according to the configuration, type, specification, and the like of the downstream load module 20-2.

The plurality of insertion ports 14a and 14b of the standard interface 14A may be allocated to different communication ports independent from each other or communication lines of a plurality of insertion ports 14a and 14b may be connected in parallel to the same communication port.

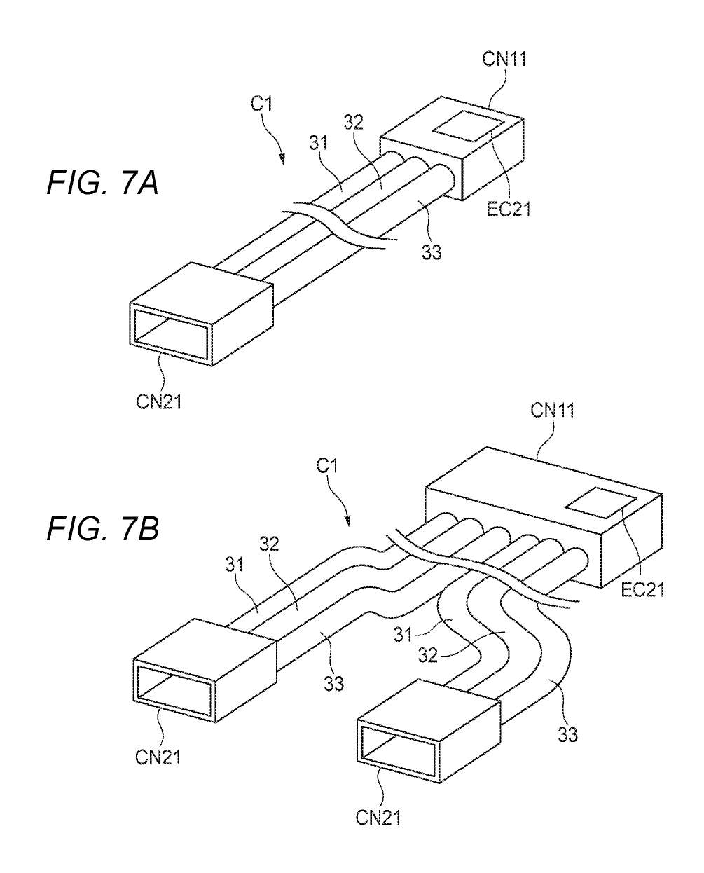

A configuration diagram of another example of the connection cable C1 illustrated in FIG. 2 is illustrated in FIGS. 7A and 7B. Configurations to which the same reference notations as in FIGS. 5A and 5B are affixed are the same as the configurations in FIGS. 5A and 5B, so the description thereof will be omitted. In the connection cable C1 illustrated in FIGS. 7A and 7B, a circuit board of the connector control unit EC21 is provided in a housing of the connector CN11, instead of the connectors CN21 and CN22. In any case of FIG. 7A or 7B, the connector control unit EC21 holds the information of a unique connector ID assigned thereto in advance and has a function of communicating with the host ECU 13 of the power distribution box 52 and a function of inputting/outputting necessary signals to/from the connector 21.

### [Operation Example of In-Vehicle Control System]

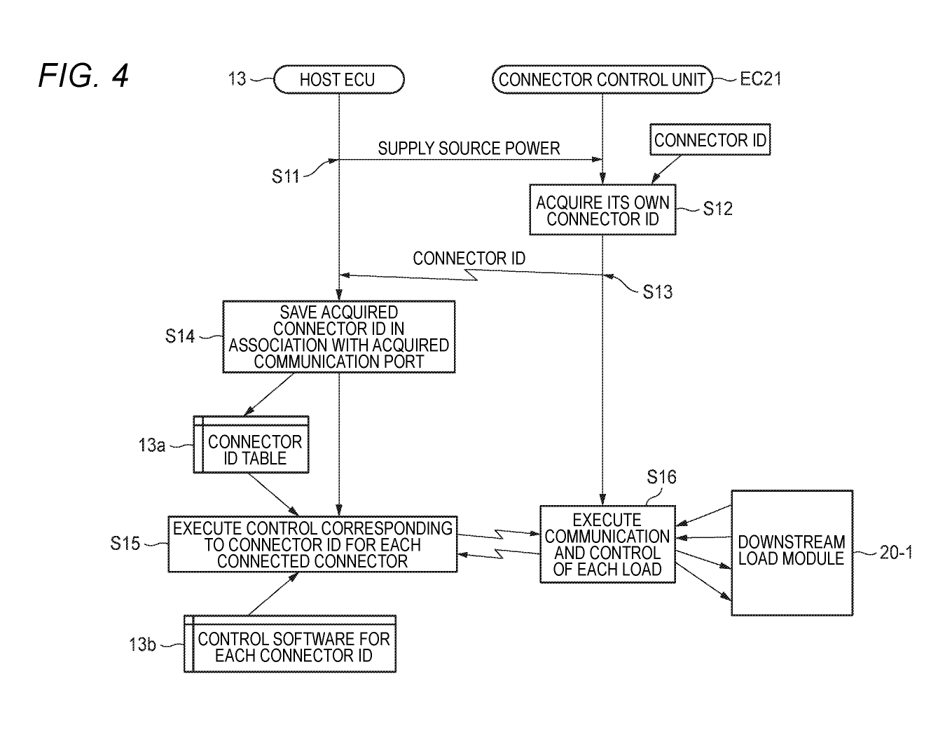

An operation example of the in-vehicle control system according to the embodiment is illustrated in FIG. 4. That is, when the power distribution box 52 and the downstream load module 20-1 and the like are connected by the connection cable C1, as illustrated in FIG. 2, control of the procedure as illustrated in FIG. 4 is executed between the host ECU 13 in the power distribution box 52 and the connector control unit EC21 in the connector CN21. The operation of FIG. 4 will be described below.

When power is supplied from the trunk line 51 to the host ECU 13, the host ECU 13 supplies electric power to the connector control unit EC21 via a power supply line of the connection cable C1 (S11).

The connector control unit EC21 starts its operation when the electric power is supplied from the connection cable C1, and acquires a connector ID held by itself from, for example, an internal memory (S12). Then, the connector control unit EC21 transmits its own connector ID to the host ECU 13 via a communication line of the connection cable C1 (S13).

The host ECU 13 receives the connector ID transmitted from the connector control unit EC21 and saves the connector ID in a connector ID table 13a in association with a communication port (S14) which has received the connector ID.

The connector ID table 13a is arranged in a nonvolatile memory in the host ECU 13 and used to hold a list of connector IDs of the respective connectors actually connected to the downstream side of the host ECU 13. For example, when the connectors CN21 and CN22 are connected to the power distribution box 52 by the connection cable C1, as illustrated in FIG. 2, the connector ID of the connector control unit EC21 in the connector CN21 and the connector ID of the connector control unit EC22 in the connector CN22 are written and held in the connector ID table 13a.

The host ECU 13 incorporates a control software holding unit 13b. The control software holding unit 13b is a storage area allocated to the nonvolatile memory or the like in the host ECU 13 and holds the control software for each connector ID registered thereto in advance.

The host ECU 13 acquires the connector ID from each connector on the downstream side, and then the host ECU 13 executes control corresponding to the connector ID for each connected connector (S15). That is, the host ECU 13 refers to the connector ID table 13a, in such a manner that the connector ID of each connected connector is determined. Therefore, the control software corresponding to each of the determined connector IDs is acquired from the control software holding unit 13b and executed.

For example, when the connectors CN21 and CN22 are connected to the power distribution box 52 by the connection cable C1, as illustrated in FIG. 2, the host ECU 13 performs communication with the connector control unit EC21 and control of the downstream load module 20-1 using control software corresponding to the connector ID of the connector control unit EC21. Further, the host ECU 13 performs communication with the connector control unit EC22 and control of the downstream load module 20-2 using control software corresponding to the connector ID of the connector control unit EC22.

Here, in the host ECU 13, a transmission destination of a signal for control software can be specified by the corresponding connector ID and communication port. Further, on the connector control unit EC21 side, by referring to the connector ID included as information such as a destination in the signal sent from the host ECU 13, it is possible to distinguish a signal addressed to itself from a signal addressed to another connector control unit EC22.

Therefore, the connector control unit EC21 performs control of each load in the downstream load module 20-1 while communicating with the host ECU 13 (S16). That is, a signal generated by the switch 22 or the sensor 23 is input from a predetermined port and the signal is encoded in a format corresponding to its own connector ID, and then the signal is transmitted to the host ECU 13. Further, a signal received from host ECU 13 is decoded in a format corresponding to its own connector ID and is output to a predetermined port, so that the load 24 or the relay 25 is controlled.

For example, in the downstream load module 20-1 illustrated in FIG. 2, when the load 24 is driven in accordance with the operation state of the switch 22, the following operation is performed. The signal output from the switch 22 is sent to the host ECU 13 in the power distribution box 52 via the connector control unit EC21 in the connector CN21, the connection cable C1, and the connector CN11. By executing the control software corresponding to the connector ID of the connector control unit EC21, the host ECU 13 processes an input signal from the switch 22 and generates a control signal for driving the load 24 according to the input signal. The control signal is output from the power distribution box 52 and received by the connector control unit EC21 in the connector CN21 via the connection cable C1. The connector control unit EC21 decodes the received control signal and outputs it to the downstream side. As a result, the energization of the load 24 is controlled. Therefore, the operation of the downstream load module 20-1 can be controlled by the host ECU 13.

In the operation example of FIG. 4, only communication between the host ECU 13 and the connector control unit EC21 is illustrated. However, communication between the host ECU 13 and the connector control unit EC22 is also the same as in FIG. 4. Further, not only the in-vehicle control system illustrated in FIG. 2 but also the in-vehicle control system illustrated in FIG. 3 can perform the same operation as in FIG. 4.

In the operation example of FIG. 4, it is assumed that the host ECU 13 obtains the connector ID from each of the connectors CN21 and CN22 on the downstream side when the host ECU 13 is powered on. However, the same processes may be executed periodically, for example.

### [Advantages of In-Vehicle Control System of Embodiment]

In a case of the in-vehicle control system illustrated in FIG. 2, a plurality of downstream load modules 20-1 and 20-2 of different types can be simply connected by connecting the connector CN11 of the connection cable C1 which is branched in the course of its length to the insertion port 14a of the standard interface 14. Further, even in a case of the configuration of FIG. 3, it is possible to connect a plurality of downstream load modules 20-1 and 20-2 of different types by connecting a plurality of connection cables C2A and C2B to a standard interface 14A of the power distribution box 52.

In addition, when the number of downstream load modules 20-1 and the like connected to the power distribution box 52 is increased, it is possible to add the downstream load modules 20-1 and the like without changing the configuration of the power distribution box 52 by adding connectors and electric wires branching in the course of a cable as similar to the connection cable C1.

For example, even when unexpected changes are made to the configuration and specifications of the downstream load module 20-1 or the like, if the connection cable is substituted with the connection cable C1 including the connector control unit EC21 to which a new connector ID is given and control software corresponding to the new connector ID is added to the control software holding unit 13b of the host ECU 13, it can be used as it is without changing other configurations.

Therefore, when the power distribution box 52 is designed for the first time, there is no need to suppose the possibility of change or addition in the future and carry out reservation design, and thus it is possible to greatly reduce development man-hours. Moreover, it is not necessary to preliminarily incorporate components with low possibility of use in the power distribution box 52, and thus it is possible to eliminate waste and to reduce the cost of parts.

Further, difference in the configuration, type and the like of the downstream load modules 20-1, 20-2, and the like connected to the downstream side of the connection cable C1 and the like can be distinguished by the connector ID given in advance to each of the connector control units EC21 and EC22, and thus a common standardized standard interface (14, 14A) can be adopted for the output of the power distribution box 52. With such commonality, the types of parts and the number of article numbers are reduced, and thus the management cost and the manufacturing cost of parts are reduced.

Here, the features of the in-vehicle control system and the wire harness according to the embodiment of the invention described above are briefly summarized in the following [1] to [6] and listed below.

[1] An in-vehicle control system comprising:

a power distribution box (52) which supplies electric power to a downstream side;

an in-vehicle device (downstream load module 20-1 or 20-2) having one or more loads; and

a connection cable (C1, C2A, or C2B) which connects the power distribution box to the in-vehicle device disposed in the downstream side of the power distribution box,

wherein the power distribution box includes a host controller (host ECU 13),

wherein at least one connector attached to the connection cable includes a connector control unit (EC21 or EC22), and

wherein the host controller acquires via the connection cable and holds connector identification information (connector ID) previously assigned to the connector control unit.

[2] The in-vehicle control system according to [1],

wherein the power distribution box includes a plurality of standardized insertion ports (14a and 14b) to which one end of the connection cable (C2A or C2B) is connectable, and

wherein the host controller acquires the connector identification information via the connection cable according to a common control procedure even when the connection cable is connected to any of the plurality of standardized insertion ports (S14).

[3] The in-vehicle control system according to [1],

wherein the connection cable (C1) includes a branch portion (C1a) which branches to a plurality of paths,

wherein a plurality of the connectors (CN21 and CN22) are respectively connected to the plurality of the paths in the downstream side,

wherein a plurality of the connector identification information which is different is respectively assigned to the plurality of the connectors, and

wherein a plurality of the in-vehicle devices are respectively connected to the plurality of the connectors.

[4] The in-vehicle control system according to any one of [1] to [3],

wherein the in-vehicle device includes a plurality of the loads or signal input devices (switch 22, sensor 23, load 24, relay 25, and the like), and

wherein the connector control unit controls the plurality of the loads or the signal input device according to an instruction from the host controller (S16).

[5] The in-vehicle control system according to any one of [1] to [4],

wherein the host controller has a plurality of control operations (respective types of control software in control software holding unit 13b) which respectively correspond to the plurality of the connector identification information, and

wherein the host controller controls the connector control unit with the control operation which is selected according to the connector identification information acquired via the connection cable (S15).

[6] A wire harness comprising:

a power distribution box (52) which supplies electric power to an in-vehicle device (downstream load module 20-1 or 20-2) disposed in a downstream side and including one or more loads;

a connection cable (C1, C2A, or C2B) which connects the power distribution box to the in-vehicle device; and

a connector including a circuit board which is built in the connector and holds connector identification information (connector ID) referred by a host controller (host ECU 13) which the power distribution box includes.

What is claimed is:

1. An in-vehicle control system comprising:
a power distribution box which supplies electric power to a downstream side;
an in-vehicle device having one or more loads; and
a connection cable which connects the power distribution box to the in-vehicle device disposed in the downstream side of the power distribution box,
wherein the power distribution box includes a host controller,
wherein at least one connector attached to the connection cable includes a connector control unit, and
wherein the host controller acquires via the connection cable and holds connector identification information previously assigned to the connector control unit.

2. The in-vehicle control system according to claim 1,
wherein the power distribution box includes a plurality of standardized insertion ports to which one end of the connection cable is connectable, and
wherein the host controller acquires the connector identification information via the connection cable according to a common control procedure even when the connection cable is connected to any of the plurality of standardized insertion ports.

3. The in-vehicle control system according to claim 1,
wherein the connection cable includes a branch portion which branches to a plurality of paths,
wherein a plurality of the connectors are respectively connected to the plurality of the paths in the downstream side,
wherein a plurality of the connector identification information which is different is respectively assigned to the plurality of the connectors, and
wherein a plurality of the in-vehicle devices are respectively connected to the plurality of the connectors.

4. The in-vehicle control system according to claim 1,
wherein the in-vehicle device includes a plurality of the loads or signal input devices, and
wherein the connector control unit controls the plurality of the loads or the signal input device according to an instruction from the host controller.

5. The in-vehicle control system according to claim 1,
wherein the host controller has a plurality of control operations which respectively correspond to the plurality of the connector identification information, and
wherein the host controller controls the connector control unit with the control operation which is selected according to the connector identification information acquired via the connection cable.

6. A wire harness comprising:
a power distribution box which supplies electric power to an in-vehicle device disposed in a downstream side and including one or more loads;
a connection cable which connects the power distribution box to the in-vehicle device; and
a connector including a circuit board which is built in the connector and holds connector identification information referred by a host controller which the power distribution box includes.
